(19) United States
(12) Patent Application Publication
(10) Pub. No.: US 2024/0182030 A1
(43) Pub. Date: Jun. 6, 2024

(54) VEHICLE CONTROL DEVICE

(71) Applicant: TOYOTA JIDOSHA KABUSHIKI KAISHA, Toyota-shi (JP)

(72) Inventor: Kuninori KUMAGAI, Susono-shi (JP)

(73) Assignee: TOYOTA JIDOSHA KABUSHIKI KAISHA, Toyota-shi (JP)

(21) Appl. No.: 18/471,550

(22) Filed: Sep. 21, 2023

(30) Foreign Application Priority Data
Dec. 6, 2022 (JP) 2022-195179

(51) Int. Cl. B60W 30/14; B60W 40/072; B60W 40/107; B60W 40/109

(52) U.S. Cl. CPC B60W 30/146; B60W 40/072; B60W 40/107; B60W 40/109; B60W 2520/105; B60W 2520/125; B60W 2540/10; B60W 2540/12; B60W 2552/30; B60W 2556/40

(57) ABSTRACT

A vehicle control device includes: an accelerator pedal operated by a driver; a brake pedal operated by the driver to activate a braking device; and a detection unit that detects data related to an operation state of a vehicle by the driver, and a traveling state of the vehicle. The vehicle control device is configured to enable acceleration by the driver operating the accelerator pedal, and to enable braking by the driver operating the brake pedal. When the driver releases the brake pedal and depresses the accelerator pedal in a process of decelerating the vehicle at an entrance of a curve and then accelerating the vehicle while turning in the curve, deceleration of the vehicle is set in accordance with a lateral gravitational acceleration of the vehicle detected by the detection unit at time of releasing the brake pedal.

### CROSS-REFERENCE TO RELATED APPLICATION

This application claims priority to Japanese Patent Application No. 2022-195179 filed on Dec. 6, 2022, incorporated herein by reference in its entirety.

### BACKGROUND

### 1. Technical Field

The disclosure relates to a vehicle control device.

### 2. Description of Related Art

Japanese Unexamined Patent Application Publication No. 2012-144160 (JP 2012-144160 A) discloses technology in which, when entry speed of a vehicle with respect to a curve is predicted to be excessively great, driving operations performed by a driver of the vehicle are intervened with and the vehicle is decelerated, in accordance with each of operation sections in which the driver performs driving operations that are different from one another, while the vehicle is traveling through the curve.

### SUMMARY

However, in the technology disclosed in JP 2012-144160 A, the driver may feel an unnatural sensation due to sense of deceleration at the time of releasing a brake pedal and depressing an accelerator pedal while turning.

The disclosure has been made in view of the above problems, and an object thereof is to provide a vehicle control device capable of suppressing an unnatural sensation felt by the driver, through enabling optimal control of sense of deceleration when releasing one pedal and depressing another while the vehicle is turning.

In order to solve the above problem and achieve the object, a vehicle control device according to the disclosure includes: an accelerator pedal operated by a driver; a brake pedal operated by the driver to activate a braking device; and a detection unit that detects data related to an operation state of a vehicle by the driver, and a traveling state of the vehicle, in which the vehicle control device is configured to enable acceleration by the driver operating the accelerator pedal, and to enable braking by the driver operating the brake pedal. When the driver releases the brake pedal and depresses the accelerator pedal in a process of decelerating the vehicle at an entrance of a curve and then accelerating the vehicle while turning in the curve, deceleration of the vehicle is set in accordance with a lateral gravitational acceleration of the vehicle detected by the detection unit at time of releasing the brake pedal.

Accordingly, the vehicle control device according to the disclosure is capable of suppressing an unnatural sensation felt by the driver, through enabling optimal control of sense of deceleration when releasing one pedal and depressing another while the vehicle is turning.

In addition, in the above, the deceleration may be set using a map in which a relation between the lateral gravitational acceleration of the vehicle and a front-rear gravitational acceleration of the vehicle is determined in advance.

Thus, the map can be used by taking the lateral gravitational acceleration as an input, to output and set the deceleration corresponding to the lateral gravitational acceleration.

The vehicle control device according to the disclosure has advantageous effects in being capable of suppressing an unnatural sensation felt by the driver, through enabling optimal control of sense of deceleration when releasing one pedal and depressing another while the vehicle is turning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a drive system and a control system of a vehicle according to an embodiment;

FIG. 2 is a flow chart illustrating an exemplary control performed by ECU according to the embodiment;

FIG. 3 is a diagram illustrating an example of a map in which a relationship between the lateral G and the front-rear G is determined in advance;

FIG. 4 is a diagram illustrating a first exemplary method of determining a target accelerator OFF deceleration according to a braking force;

FIG. 5 is a diagram illustrating a second exemplary method of determining a target accelerator OFF deceleration according to a braking operation amount;

FIG. 6 is a diagram illustrating the time-series timing corresponding to the respective processes in the flow chart shown in FIG. 2; and

FIG. 7 is a diagram illustrating a time chart when the control of each process in the flowchart illustrated in FIG. 2 is executed.

### DETAILED DESCRIPTION OF EMBODIMENTS

Hereinafter, an embodiment of a vehicle control device according to the present disclosure will be described. This embodiment is not intended to limit the present disclosure.

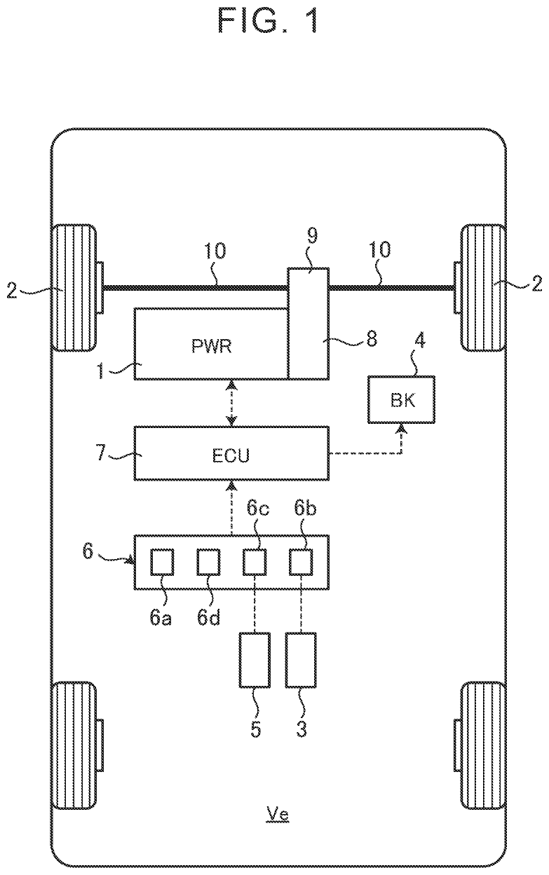

FIG. 1 is a diagram illustrating an exemplary drive system and a control system of a vehicle Ve according to an embodiment. The vehicle Ve shown in FIG. 1 typically includes a driving force source (PWR) 1, driving wheels 2, an accelerator pedal 3, a braking device (BK) 4, a brake pedal 5, a detection unit 6, and a ECU 7.

The driving force source 1 is, for example, an internal combustion engine such as a gasoline engine or a diesel engine. The driving force source 1 is configured such that the output is adjusted and the operating states such as starting and stopping are electrically controlled. The driving force source 1 in the present embodiment may be, for example, a permanent magnet synchronous motor or an electric motor such as an induction motor. The electric motor in this case may be, for example, a so-called motor generator having a function as a prime mover that is driven by being supplied with electric power and outputs motor torque, and a function as a generator that generates electricity by being driven by receiving torque from the outside.

The driving wheels 2 generate the driving force of the vehicle Ve by transmitting the driving torque outputted from the driving force source 1. In the embodiment shown in FIG. 1, the driving wheel 2 is connected to a driving force source 1 via a transmission 8, a differential gear 9 and a drive shaft 10. As illustrated in FIG. 1, the vehicle Ve according to the present embodiment may be a front wheel drive vehicle that transmits a drive torque to the front wheels and generates a driving force by the front wheels. Alternatively, the vehicle Ve may be a rear wheel drive vehicle that transmits a drive torque to the rear wheel via, for example, a propeller shaft, and generates a driving force by the rear wheel. Alternatively, the vehicle Ve may be a four-wheel drive vehicle in which a transfer mechanism is provided to transmit a driving torque to both the front wheel and the rear wheel, and a driving force is generated by both the front wheel and the rear wheel.

The vehicle Ve includes an accelerator pedal 3 for allowing a driver to adjust a driving force to accelerate the vehicle Ve. When the accelerator pedal 3 is depressed, the throttle position increases corresponding to the operation amount of the accelerator pedal 3. Here, the operation amount of the accelerator pedal 3 is a depression amount of the accelerator pedal 3 or an accelerator operation amount or an accelerator position. The throttle position is, for example, an opening degree of a throttle valve of a gasoline engine or a fuel injection amount of a diesel engine. As a consequence, the driving torque increases, and the driving force of the vehicle Ve increases. On the other hand, when the depression of the accelerator pedal 3 is returned (the operation amount is reduced or the accelerator operation amount or the accelerator position is lowered), the throttle position is lowered corresponding to the operation amount of the accelerator pedal 3. Consequently, the driving torque is reduced, and the driving force of the vehicle Ve is reduced. In addition, as the driving force decreases, the braking force of the vehicle Ve increases. That is, when the accelerator pedal 3 is depressed back, so-called engine braking acts, and the braking force of the vehicle Ve increases. Alternatively, when an electric motor is mounted as the driving force source 1, the electric motor functions as a regenerative braking, and a regenerative braking force is generated on Ve of the vehicle.

As described above, the accelerator pedal 3 adjusts the driving force and the braking force of the vehicle Ve by operating the driver. The accelerator pedal 3 is provided with an accelerator position sensor 6b for detecting an operation amount and an operation speed in the depression operation of the accelerator pedal 3 by the driver. The accelerator position sensor 6b can detect the manipulated variable (accelerator operation amount or accelerator position) of the accelerator pedal 3. In addition, by detecting the operation velocity of the accelerator pedal 3 by the accelerator position sensor 6b, the operation condition and the operation orientation of the accelerator pedal 3 by the driver can be determined. That is, it can be determined whether the accelerator pedal 3 is depressed by the driver or whether the accelerator pedal 3 is depressed back by the driver.

The braking device 4 is a device that generates a braking force on the vehicle Ve. As the braking device 4, for example, a hydraulic disc brake, a drum brake, or the like is used. In the vehicle Ve according to the present embodiment, the braking device 4 is controlled and operated by ECU 7. The vehicle Ve includes a brake pedal 5 for allowing a driver to operate the braking device 4 to adjust a braking force generated by the braking device 4 to perform a braking operation on the vehicle Ve. Therefore, the braking device 4 is operated by the driver depressing the brake pedal 5 to generate a braking force on Ve of the vehicle. Further, the brake pedal 5 is provided with a brake stroke sensor 6c for detecting an operation amount and an operation speed in the depression operation of the brake pedal 5 by the driver. By detecting the operating speed of the brake pedal 5 by the brake stroke sensor 6c, the operating state and the operating direction of the brake pedal 5 by the driver can be determined. That is, it can be determined whether the brake pedal 5 is depressed by the driver or whether the brake pedal 5 is depressed back by the driver. The manipulated variable of the brake pedal 5 may be calculated from the stroke of the brake pedal 5 detected by the brake stroke sensor 6c, or may be calculated using the torque converted from the stroke.

Instead of the above-described brake stroke sensor 6c, a brake switch that detects the operating condition of the brake pedal 5 (ON·OFF of the braking device 4 or the operating quantity of the brake pedal 5) by the driver may be used.

The detection unit 6 is a device or a device for acquiring various types of data and information required for controlling the vehicle Ve, and includes, for example, a power supply unit, a microcomputer, a sensor, an input/output interface, and the like. In particular, the detection unit 6 in the present embodiment includes a wheel speed sensor 6a for detecting the rotational speed of the wheels, and an accelerator position sensor 6b for detecting an operation amount (that is, an accelerator position or an accelerator operation amount) and an operation speed of the accelerator pedal 3. In addition, the detection unit 6 includes, for example, a brake stroke sensor 6c that detects an operation amount and a pedaling force of the brake pedal 5, and an acceleration sensor 6d that detects the longitudinal acceleration (front-rear G) of the vehicle Ve. In the present embodiment, the longitudinal acceleration in the negative direction of the vehicle Ve, that is, the acceleration in the direction of decelerating the vehicle Ve, is defined as “deceleration”. Further, the detection unit 6 includes, for example, a steering angle sensor that detects a steering angle from a steering angle manipulation of a steering wheel by a driver, a gyro sensor that is an acceleration sensor that detects a lateral acceleration (lateral G) of the vehicle Ve, and the like. Note that the lateral G may be estimated by ECU 7 from, for example, the R-shape of the corner at which the vehicle Ve is going and the present vehicle speed. The detection unit 6 is electrically connected to ECU 7, and outputs an electric signal corresponding to a detection value or a calculated value of the various sensors, devices, and the like as described above to ECU 7 as detection data.

ECU 7 is, for example, an electronic control unit mainly composed of a microcomputer. ECU 7 in the present embodiment mainly controls operations of the driving force source 1, the braking device 4, the transmission 8, and the like. Various types of data detected or calculated by the detection unit 6 are inputted to ECU 7. ECU 7 performs an operation using various types of inputted data, data stored in advance, a computation equation, and the like. At the same time, ECU 7 is configured to control the operation of the driving force source 1, the braking device 4, the transmission 8, and the like, as described above, by outputting the calculation result as a control command signal.

For example, ECU 7 calculates the target driving torque of the driving force source 1 based on the operating amount of the accelerator pedal 3 detected by the accelerator position sensor 6b and the vehicle speed calculated from the detected value of the wheel speed sensor 6a. Then, the output of the driving force source 1 is controlled based on the target driving torque. In addition, ECU 7 controls the gear ratio or the gear stage set by the transmission 8. In addition, ECU 7 controls the driving force generated in the vehicle Ve in accordance with the manipulated variable and the manipulated velocity of the accelerator pedal 3 detected by the accelerator position sensor 6b. Alternatively, ECU 7 controls the braking force generated in Ve of the vehicle in accordance with the manipulation amount and the pedaling force of the brake pedal 5. Note that, although FIG. 1 illustrates an embodiment in which one ECU 7 is provided, a plurality of ECU 7 may be provided, for example, for each device or device to be controlled, or for each control content.

ECU 7 according to the embodiment sets the deceleration of the vehicle Ve according to the lateral G of the vehicle Ve when the vehicle Ve decelerates from the front side of the curve and accelerates during the turning of the curve, and when the pedal is changed from the brake pedal 5 to the accelerator pedal 3, the deceleration is determined according to the lateral G of the vehicle Ve when the brake pedal 5 detected by the detection unit 6 is released.

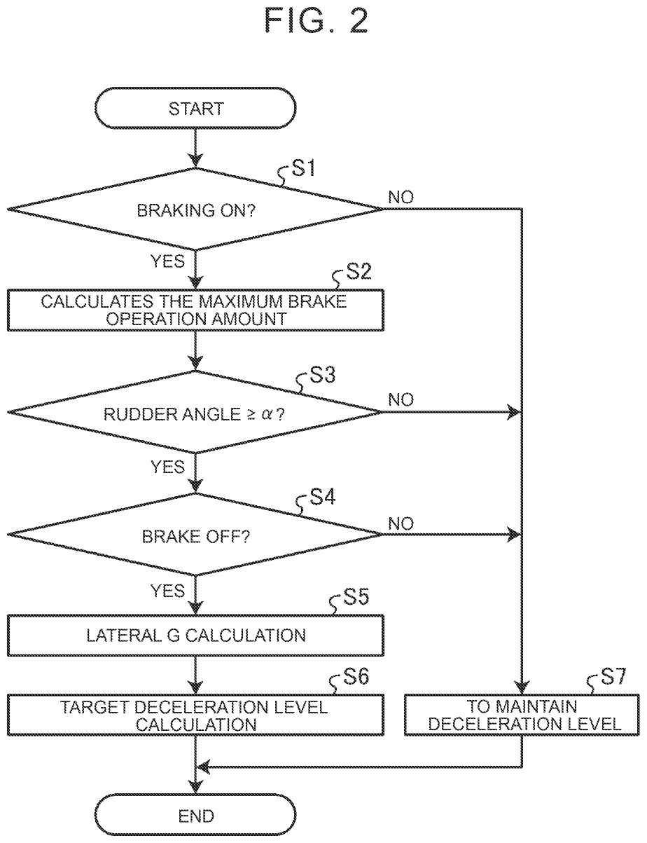

FIG. 2 is a flow chart illustrating an exemplary control performed by ECU 7 according to the embodiment.

First, ECU 7 determines whether braking is ON (S1). If ECU 7 determines that braking is OFF (No at S1), it maintains the deceleration level (S7). ECU 7 then terminates the series of controls. On the other hand, when ECU 7 determines that the brake is ON (Yes in S1), it calculates the maximum-operating-amount-of-brake (S2). Next, ECU 7 determines whether or not the steering angle is equal to or greater than a predetermined value a from the steering angle manipulation of the driver (S3). When determining that the steering angle is less than the predetermined value a (No in S3), ECU 7 maintains the deceleration level (S7). ECU 7 then terminates the series of controls. On the other hand, when it is determined that the steering angle is equal to or greater than the predetermined value a (Yes in S3), ECU 7 determines that the vehicle Ve is turning and determines whether or not the braking is OFF (S4). If ECU 7 determines that braking is ON (No at S4), it maintains the deceleration level (S7). ECU 7 then terminates the series of controls. On the other hand, when ECU 7 determines that the brake is OFF (Yes in S4), it calculates the lateral G at the time of pedal-changing (at the time of brake-off) (S5). Next, ECU 7 calculates and sets a deceleration (target deceleration level) corresponding to the calculated lateral G (S6). ECU 7 then terminates the series of controls.

It should be noted that, when the turning determination in S3 is No, for example, a conventional technique in a straight line scene may be utilized as disclosed in Japanese Unexamined Patent Application Publication No. 2022-62856 (JP 2022-62856 A).

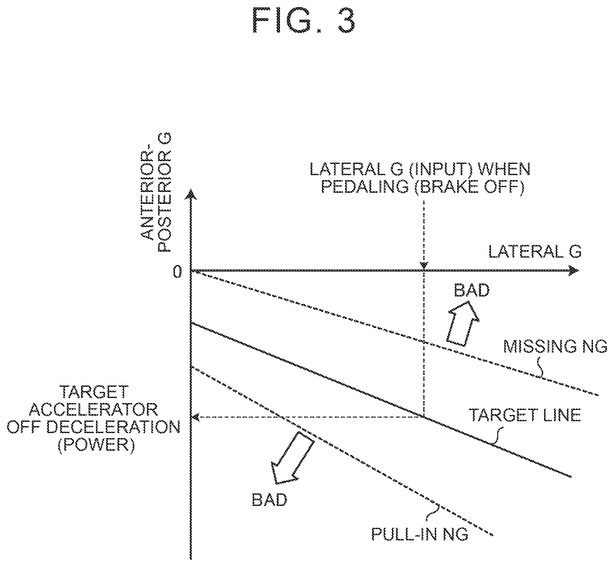

Next, a method of determining the target accelerator OFF deceleration according to the lateral G will be described. Note that the target accelerator OFF deceleration is a deceleration that is a target when both the brake and the accelerator are OFF when the pedal is switched from the brake pedal 5 to the accelerator pedal 3. FIG. 3 is a diagram illustrating an example of a map in which the relationship between the lateral G and the front-rear G is determined in advance.

In the present embodiment, as illustrated in FIG. 3, a non-defective product zone in which neither the pull-in feeling nor the pull-out feeling is relatively felt is defined in advance by a map in which the relation between the side G of the vehicle Ve and the front-rear G of the vehicle Ve is determined in advance. The non-defective zone is the area between the dashed line of the pull-in feeling NG and the dashed line of the pull-out feeling NG in FIG. 3. Then, ECU 7 uses the map to calculate a target accelerator OFF deceleration corresponding to the input-side G. In the present embodiment, for example, as illustrated in FIG. 3, the correspondence relation between the lateral G and the target accelerator OFF deceleration is set as the target line. Accordingly, by using the map, ECU 7 can set the deceleration by outputting the target accelerator OFF deceleration corresponding to the target line by inputting the lateral G when the pedal is switched from the brake pedal 5 to the accelerator pedal 3 (when the brake is off).

The non-defective product zone is determined from, for example, the sensory function of the driver. In addition, as the target line that is hardly felt by both the pull-in feeling and the pull-out feeling, it is preferable to set the center line of the non-defective zone. The target-line may be freely designed according to the magnitude of the target accelerator OFF deceleration (prior to control intervention) in the elementary condition of the vehicle Ve. For example, in a case where the original deceleration is a strong deceleration such as a one-pedal mode, the target line is set to be closer to the pull-in feeling (closer to the strong deceleration) with the aim of ensuring reproducibility to an operation caused by a large change in the deceleration. Note that the one-pedal mode is a mode in which both the driving force and the braking force can be controlled by operating one pedal such as the accelerator pedal 3 to steer the vehicle Ve. On the other hand, when the original deceleration is weak, the target line is set to a slip-off feeling (weak deceleration).

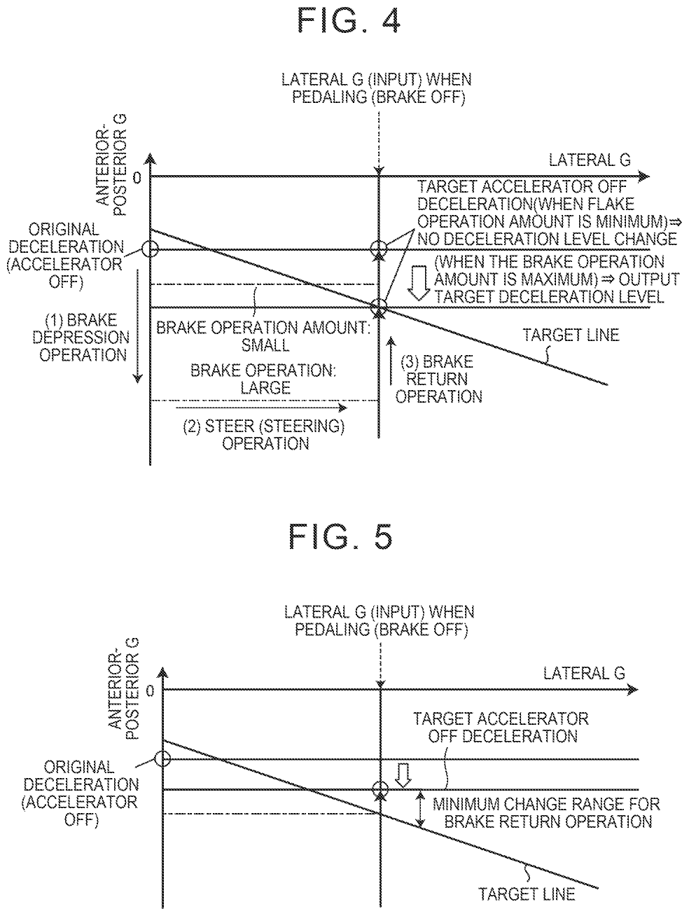

Next, a method of determining the target accelerator OFF deceleration according to the braking force will be described. FIG. 4 is a diagram illustrating a first exemplary method of determining a target accelerator OFF deceleration according to a braking operation amount. FIG. 5 is a diagram illustrating a second exemplary method of determining a target accelerator OFF deceleration according to a braking operation amount.

When the method of determining the target accelerator OFF deceleration corresponding to the lateral G as described with reference to FIG. 3 is performed, the deceleration during outputting may not reach the target accelerator OFF deceleration depending on the brake operation amount when the brake depression operation is performed in front of the curve. For example, as shown in FIG. 4, the braking operation amount in front of the curve is small, and the total amount of the original deceleration and the deceleration by the braking operation is equal to or less than the target accelerator OFF deceleration corresponding to the lateral G at the time of pedaling (at the time of brake-off). The original deceleration is the deceleration prior to control intervention at the accelerator OFF. In this case, when the target accelerator OFF deceleration is to be realized, even if the brake pedal 5 is released for acceleration and the brake return operation is performed after the steering operation in the curve, there is a possibility that the driver feels uncomfortable due to the misalignment in that the deceleration is increased. Therefore, in such a case, the deceleration level is not changed, and the deceleration level is kept as the original deceleration. On the other hand, when the brake operation amount in front of the curve is sufficiently large, the target accelerator OFF deceleration calculated from the target line corresponding to the lateral G at the time of pedal change (at the time of brake-off) is outputted when the brake return operation is performed for acceleration after the steer (steering) operation in the curve.

Further, in order to eliminate the driver's uncomfortable feeling at the time of the brake return operation, the minimum value of the change range of the deceleration with respect to the brake return operation is set. When the change range of the deceleration with respect to the brake return operation cannot satisfy the predetermined value, the minimum value of the change range of the deceleration is prioritized, and as shown in FIG. 5, a deceleration smaller than the target line and larger than the original deceleration is output.

As described above, ECU 7 calculates the target accelerator OFF deceleration corresponding to the lateral G and the braking manipulated variable, and reflects the calculated deceleration to the vehicle control. Accordingly, the driver's uncomfortable feeling with respect to the brake OFF during turning of the vehicle Ve can be suppressed, and the lateral G during turning can be suppressed.

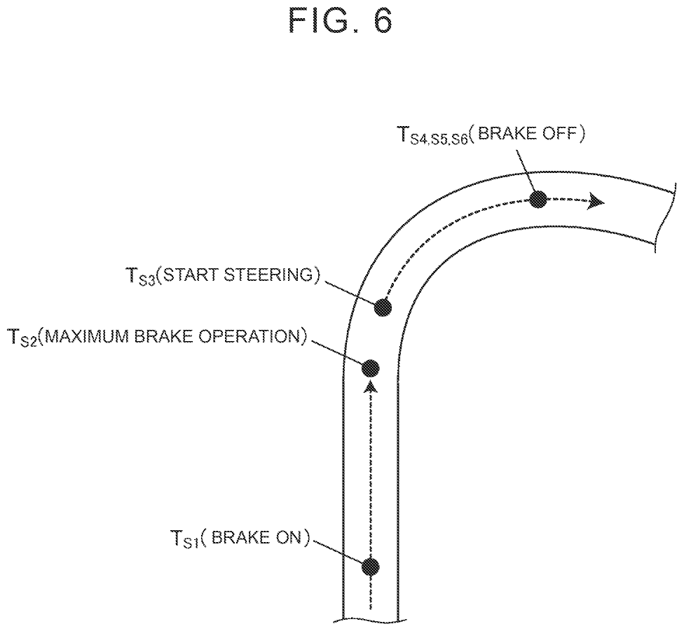

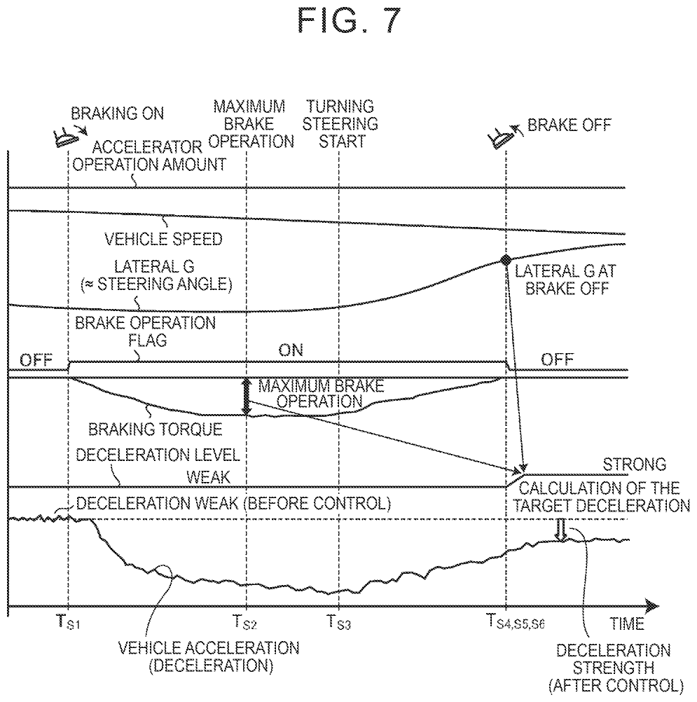

FIG. 6 is a diagram illustrating a definition of time-series timing corresponding to each process in the flowchart illustrated in FIG. 2. FIG. 7 is a diagram illustrating a time chart when control of each process in the flowchart illustrated in FIG. 2 is executed. In FIGS. 6 and 7, the T_{S1} is the time at which the control of the process of S1 of the flow chart shown in FIG. 2 is executed. In FIGS. 6 and 7, the T_{S2} is the time at which the control of S2 process in the flow chart shown in FIG. 2 is executed. In FIGS. 6 and 7, the T_{S3} is the time at which the control of S3 process in the flow chart shown in FIG. 2 is executed. In FIGS. 6 and 7, T_{S4,S5,S6} is the time at which S4 process, S5 process, and S6 process of the flow chart shown in FIG. 2 are controlled.

As can be seen from FIGS. 6 and 7, ECU 7 calculates the target accelerator OFF deceleration from the maximal brake manipulated variable calculated at the time T_{S2} and the lateral G at the time of brake OFF calculated at the time T_{S4,S5,S6}. Thus, the target accelerator OFF deceleration is outputted.

What is claimed is:

1. A vehicle control device comprising:
an accelerator pedal operated by a driver;
a brake pedal operated by the driver to activate a braking device; and
a detection unit that detects data related to an operation state of a vehicle by the driver, and a traveling state of the vehicle, wherein:
the vehicle control device is configured to enable acceleration by the driver operating the accelerator pedal, and to enable braking by the driver operating the brake pedal; and
when the driver releases the brake pedal and depresses the accelerator pedal in a process of decelerating the vehicle at an entrance of a curve and then accelerating the vehicle while turning in the curve, deceleration of the vehicle is set in accordance with a lateral gravitational acceleration of the vehicle detected by the detection unit at time of releasing the brake pedal.

2. The vehicle control device according to claim 1, wherein the deceleration is set using a map in which a relation between the lateral gravitational acceleration of the vehicle and a front-rear gravitational acceleration of the vehicle is determined in advance.
